(19) United States
(12) Patent Application Publication
(10) Pub. No.: US 2011/0153811 A1
(43) Pub. Date: Jun. 23, 2011

(54) SYSTEM AND METHOD FOR MODELING ACTIVITY PATTERNS OF NETWORK TRAFFIC TO DETECT BOTNETS

(76) Inventors: Hyun Cheol Jeong, Seoul (KR); Chae Tae IM, Seoul (KR); Seung Gao Ji, Gyeonggi-do (KR); Joo Hyung Oh, Seoul (KR); Dong Wan Kang, Seoul (KR); Tae Jin Lee, Seoul (KR); Yong Geun Won, Seoul (KR)

(21) Appl. No.: 12/821,510

(22) Filed: Jun. 23, 2010

(30) Foreign Application Priority Data
Dec. 18, 2009 (KR) 10-2009-0126884
Dec. 18, 2009 (KR) 10-2009-0126905

(51) Int. Cl. G06F 15/173

(52) U.S. Cl. 709/224

(57) ABSTRACT

The invention relates to a system and method that can detect botnets by classifying the communication activities for each client according to destination or based on similarity between the groups of collected traffic. According to certain aspects of the invention, the communication activities for each client can be classified to model network activity by differentiating the protocols of the collected network traffic based on destination and patterning the subgroups for the respective protocols. Those servers that are estimated to be C&C servers can be classified into download and upload, spam servers and command control servers, within a botnet group detected by modeling network activity, i.e. analyzing network-based activity patterns. Also, botnet groups can be detected by way of a group information management function, for generating an activity pattern-based group matrix based on group data, and a mutual similarity analysis, performed on groups suspected to be botnets from the group information.

### CROSS-REFERENCE TO RELATED APPLICATIONS

This application claims the benefit of Korean Patent Application No. 10-2009-0126884, filed with the Korean Intellectual Property Office on Dec. 18, 2009, and Korean Patent Application No. 10-2009-0126905, filed with the Korean Intellectual Property Office on Dec. 18, 2009, the disclosure of which is incorporated herein by reference in its entirety.

### BACKGROUND

1. Technical Field

The present invention relates to a system and method for modeling activity patterns of network traffic to detect botnets, more particularly to a method and system that can classify the communication activities for each client to model network activity by differentiating the protocols of the collected network traffic based on destination and patterning the subgroups for the respective protocols.

2. Description of the Related Art

A bot, which is short for robot, refers to a personal computer (PC) that is infected by malicious software. A botnet refers to a form of network in which many such computers infected by bots are connected together. A botnet may be remotely manipulated by a bot master to be used in various malicious activity such as DDoS attacks, theft of personal information, phishing, distributing malicious code, dispatching spam mail, etc. A botnet can be classified according to the protocol used by the botnet.

Attacks incurred through botnets are continuously increasing, and the methods employed for such attacks are increasing in variety. Instead of triggering errors in an Internet service through a DDoS attack, some bots may trigger errors in a personal system or may illegally acquire personal information. There is no lack of examples in which the illegal acquirement of user information, such as ID's and passwords, banking information, etc., was used in cybercrimes. Moreover, whereas a hacking attack of the past may have been for a hacker to show off one's capabilities or to compete with other hackers in a community, a hacking attack using a botnet may be used repeatedly by a group of hackers in a cooperative manner for monetary gains.

However, as botnets employ cutting edge technology, such as regular updates, runtime packer technology, self-modifying codes, command channel encryption, etc., it is becoming more difficult to detect and avoid botnets. What makes the problem more serious is that the source codes for botnets are open to the public, so that thousands of variations have been created, and the code for a botnet can easily be generated or controlled through of a user interface, so that people who do not have professional knowledge or technical expertise may make and misuse botnets. Bot zombies which compose a botnet may be distributed across networks of Internet service providers all over the world, and even the bot C&C (command and control server) that controls the bot zombies can be relocated to different networks.

As such, there are currently many research efforts that focus on the serious problems caused by botnets. However, it is difficult to identify the overall composition and distribution of a botnet simply by detecting the botnet as found in the network of a particular Internet service provider, and considering the great number of variations, etc., there is a need for a method for detecting a botnet more easily.

### SUMMARY

An aspect of the invention is to provide a system and a method for modeling activity patterns of network traffic that can effectively detect a botnet.

To achieve the objective above, an aspect of the invention provides a system for modeling activity patterns of network traffic to detect botnets that includes: a botnet traffic collector sensor configured to collect traffic within a network and classify the traffic according to destination; and a botnet detector system configured to detect a botnet based on botnet traffic collected by the botnet traffic collector sensor. The botnet detector system can arrange the traffic classified according to destination into groups for different time periods and can detect a botnet group having a particular access pattern exceeding a threshold number. The botnet traffic collector sensor can include: a traffic information collector module configured to collect traffic by capturing packets of a monitored network according to a collecting policy using a packet capturing tool; a traffic information manager module configured to classify information received from the traffic information collector module, receive and parse traffic information, process group data, and store/manage the traffic information in a database; a traffic information transmitter module configured to differentiate the traffic information parsed at the traffic information manager module into a transmission header and transmission data, package the data, and transmit the data by way of a transmission channel; and a sensor policy manager module configured to transmit settings/status information of a classification tool, a traffic information manager tool, and data transmission cycle information to the traffic information collector module, the traffic information manager module, and the traffic information transmitter module. The traffic information manager module can classify patterns of the collected network traffic into transmission control protocols (TCP) and user datagram protocols (UDP). The traffic information manager module can classify the transmission control protocols (TCP) into hypertext transport protocols (HTTP), simple mail transfer protocols (SMTP), and other transmission control protocols besides the hypertext transport protocols and the simple mail transfer protocols, and can classify the hypertext transport protocols into “requests” for pages and “responses” from servers to user requests. For a simple mail transfer protocol (SMTP), the simple mail transfer protocol communication itself can be used as the pattern data, and for a user data protocol (UDP), the user datagram protocol communication itself can be determined as the pattern data. The “request” can be classified into a host portion, which is the domain of the target of the request for a web server resource, a page portion, which includes information on a particular page desired by the host, and a referrer portion, which includes information on steps preceding a website currently accessed. The traffic information manager module can classify the user datagram protocols (UDP) into a domain name server (DNS) and other user datagram protocols besides the domain name server.

Another aspect of the invention provides a method for modeling activity patterns of network traffic to detect botnets that includes: collecting traffic; classifying protocols of the collected traffic; and modeling activities for the classified traffic. The operation of classifying the collected traffic can include: arranging the collected traffic into client sets according to destination; and extracting feature elements of the traffic arranged into client sets according to destination. The operation of arranging the collected traffic into client sets according to destination can include: storing access records of the collected traffic; and arranging the collected traffic into client sets according to destination.

Yet another aspect of the invention provides a method for modeling activity patterns of network traffic to detect botnets that includes: collecting traffic; generating group information for the collected traffic; and determining a botnet group based on the group information, where the group information includes group data and a group matrix, the group data including information on a plurality of sources for a single destination, and the group matrix including stored data obtained after analyzing an IP count according to an access activity pattern occurring in the group data. Here, the operation of generating the group information for the collected traffic can include: classifying the collected traffic according to protocol. The operation of classifying the collected traffic according to protocol can include: arranging the collected traffic into client sets according to destination. The operation of determining the botnet group based on the group information can include: managing group matrices; and, if a particular access pattern exceeds a threshold number for each of the group matrices, selecting the corresponding group as an analysis target group. The operation of managing the group matrices can include: generating a group matrix if the group matrix does not exist; updating the group matrix if the group matrix does exist; and deleting the group matrix if the group matrix has not been updated for a particular duration or by a particular proportion. The method can further include an operation of analyzing client similarity with respect to a particular access pattern for the group matrices selected as analysis targets. The operation of analyzing client similarity can include, if the client similarity with respect to a particular access pattern for the group matrices is greater than a particular value for the group matrices of which the similarity is compared, among the group matrices selected as analysis targets, then determining that the group matrices of which the similarity is compared belong to a same botnet group.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the schematics of a system for modeling activity patterns of network traffic to detect botnets according to an embodiment of the invention.

FIG. 2 illustrates the composition of a system for modeling activity patterns of network traffic to detect botnets according to an embodiment of the invention.

FIG. 3 illustrates the schematics of a botnet traffic collector sensor in a system for modeling activity patterns of network traffic to detect botnets according to an embodiment of the invention.

FIG. 4 illustrates the schematics of a traffic information collector module in a system for modeling activity patterns of network traffic to detect botnets according to an embodiment of the invention.

FIG. 5 illustrates the composition of a traffic information manager module in a system for modeling activity patterns of network traffic to detect botnets according to an embodiment of the invention.

FIG. 6 illustrates the modeling of a TCP access pattern in a system for modeling activity patterns of network traffic to detect botnets according to an embodiment of the invention.

FIG. 7 illustrates the modeling of a UDP access pattern in a system for modeling activity patterns of network traffic to detect botnets according to an embodiment of the invention.

FIG. 8 illustrates the composition of a communication management module in a system for modeling activity patterns of network traffic to detect botnets according to an embodiment of the invention.

FIG. 9 illustrates the composition of a policy management module in a system for modeling activity patterns of network traffic to detect botnets according to an embodiment of the invention.

FIG. 10 illustrates the composition of a botnet detector system in a system for modeling activity patterns of network traffic to detect botnets according to an embodiment of the invention.

FIG. 11 illustrates the structure of a botnet detector system in a system for modeling activity patterns of network traffic to detect botnets according to an embodiment of the invention.

FIG. 12 illustrates the composition of a botnet group analyzer module in a system for modeling activity patterns of network traffic to detect botnets according to an embodiment of the invention.

FIG. 13 is a flowchart illustrating the operation of a botnet group analyzer module in a system for modeling activity patterns of network traffic to detect botnets according to an embodiment of the invention.

FIG. 14 is a flowchart illustrating the operation of a group information manager module in a system for modeling activity patterns of network traffic to detect botnets according to an embodiment of the invention.

FIG. 15 is a flowchart illustrating the operation of a group data manager module in a system for modeling activity patterns of network traffic to detect botnets according to an embodiment of the invention.

FIG. 16 is a flowchart illustrating the operation of a group matrix manager module in a system for modeling activity patterns of network traffic to detect botnets according to an embodiment of the invention.

FIG. 17 is a flowchart illustrating the operation of a suspected group selector module in a system for modeling activity patterns of network traffic to detect botnets according to an embodiment of the invention.

FIG. 18 is a flowchart illustrating the operation of a suspected group comparative analysis module in a system for modeling activity patterns of network traffic to detect botnets according to an embodiment of the invention.

FIG. 19 illustrates the composition of a botnet composition analyzer module in a system for modeling activity patterns of network traffic to detect botnets according to an embodiment of the invention.

FIG. 20 is a flowchart illustrating the operation of a botnet composition analyzer module in a system for modeling activity patterns of network traffic to detect botnets according to an embodiment of the invention.

FIG. 21 is a flowchart illustrating a method for modeling activity patterns of network traffic to detect botnets according to an embodiment of the invention.

FIG. 22 is a flowchart illustrating a method for modeling activity patterns of network traffic to detect botnets according to an embodiment of the invention.

### DETAILED DESCRIPTION

A detailed description of certain embodiments of the invention will be provided below with reference to the appended drawings. However, the invention is not limited to the embodiments disclosed below and can be implemented in various forms, as the embodiments are intended simply for complete disclosure of the invention and for complete understanding of the invention by those of ordinary skill in the art. In the appended drawings, like numerals refer to like components.

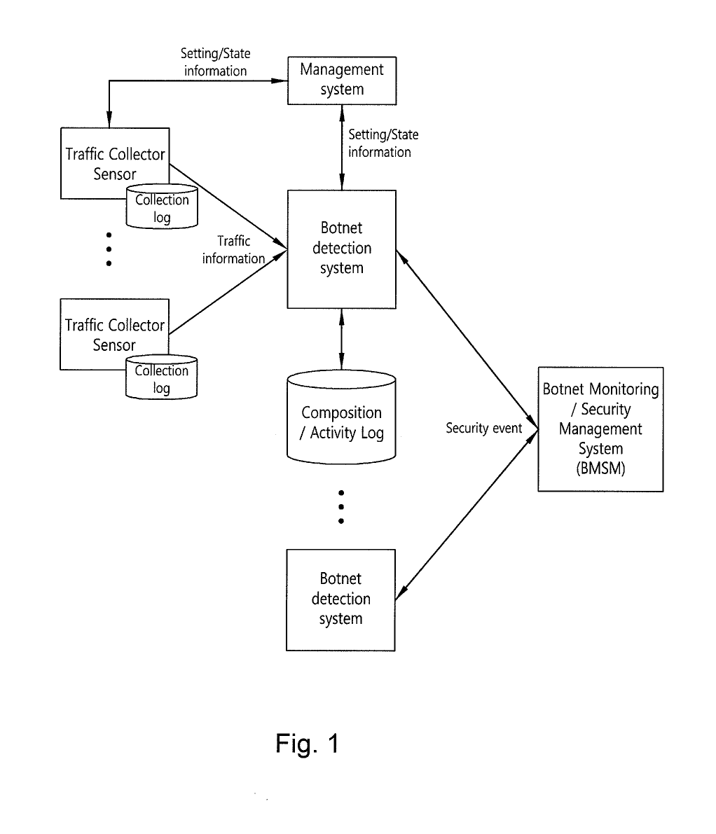

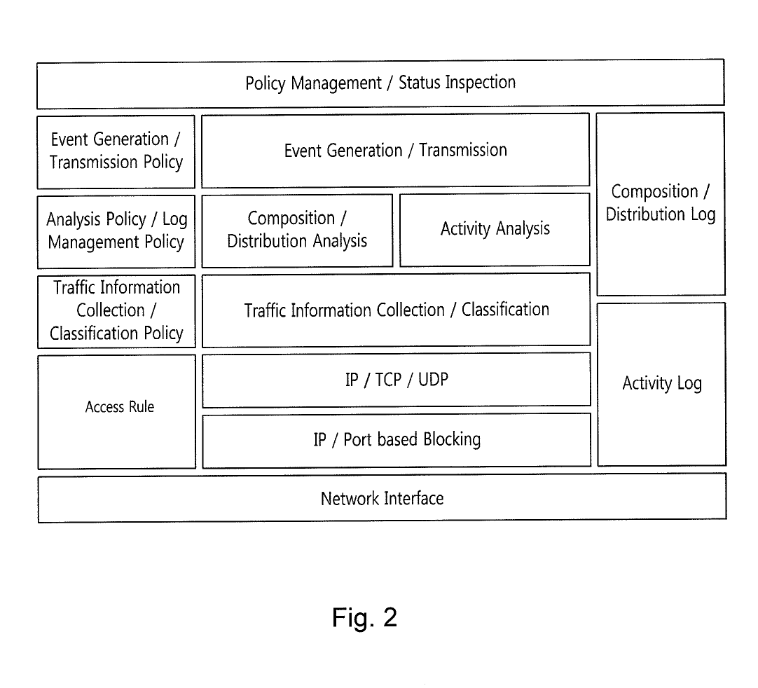

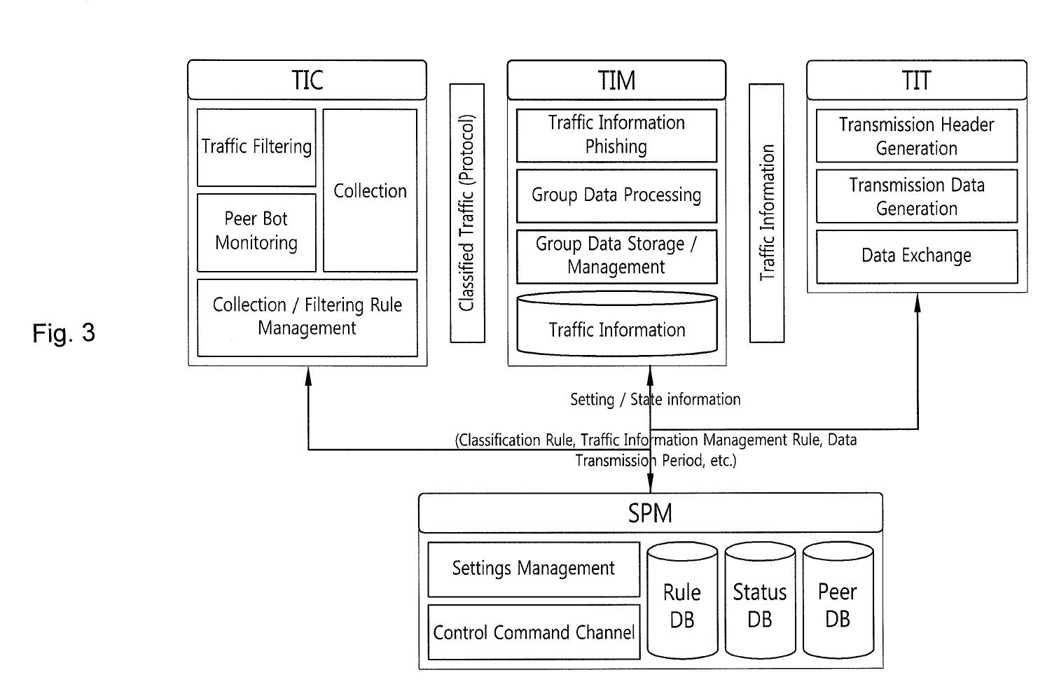

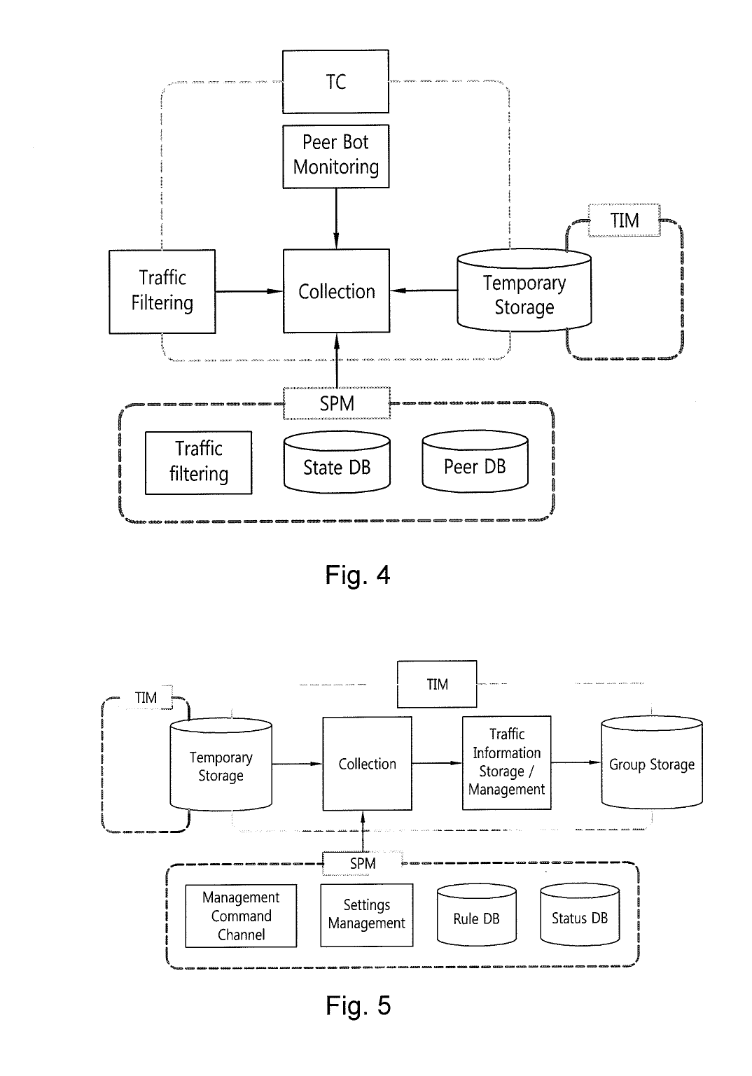

FIG. 1 illustrates the schematics of a system for modeling activity patterns of network traffic to detect botnets according to an embodiment of the invention, and FIG. 2 illustrates the composition of the system for modeling activity patterns of network traffic to detect botnets according to an embodiment of the invention. FIG. 3 illustrates the schematics of a botnet traffic collector sensor in a system for modeling activity patterns of network traffic to detect botnets according to an embodiment of the invention, and FIG. 4 illustrates the schematics of a traffic information collector module in a system for modeling activity patterns of network traffic to detect botnets according to an embodiment of the invention. FIG. 5 illustrates the composition of a traffic information manager module in a system for modeling activity patterns of network traffic to detect botnets according to an embodiment of the invention.

As illustrated in FIG. 1 and FIG. 2, a system for modeling activity patterns of network traffic to detect botnets according to an embodiment of the invention may include botnet traffic collector sensors, which may collect traffic from the network of an Internet service provider in order to detect botnets, and a botnet detection system, which may detect botnets based on the botnet traffic collected by the botnet traffic collector sensors.

As illustrated in FIG. 3, a botnet traffic collector sensor may include a traffic information collector module, a traffic information manager module, a traffic information transmitter module, and a sensor policy manager module.

The traffic information collector module, as illustrated in FIG. 4, may collect traffic by using a packet capturing tool to capture the packets of a monitored network according to a collecting policy. The collected traffic information may be stored in the temporary storage of a traffic information storage, and the collected information stored in the temporary storage may be processed again at the traffic information manager module.

The traffic information manager module, as illustrated in FIG. 5, may classify the information received from the traffic information collector module, receive and parse the traffic information, process the grouped activity information, i.e. the group data and peer bot information, and store/manage the relevant traffic information in a database. Here, classifying and grouping the traffic according to pattern may be performed as illustrated below.

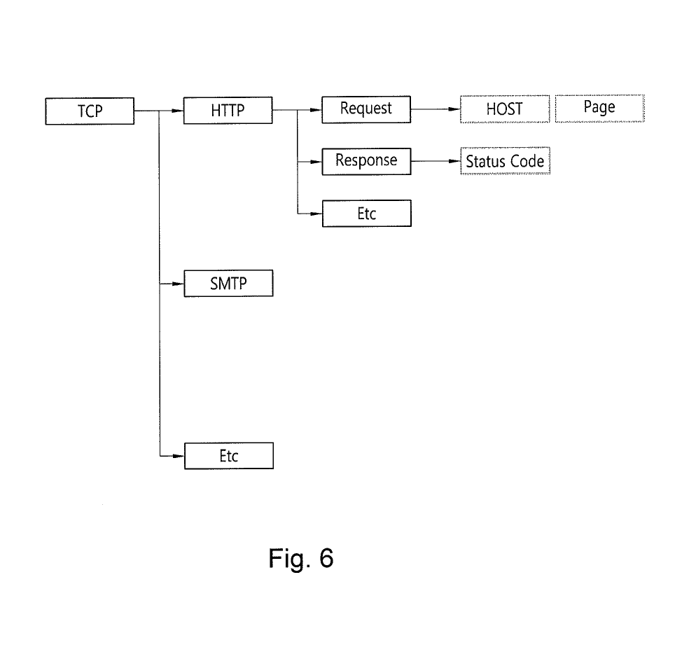

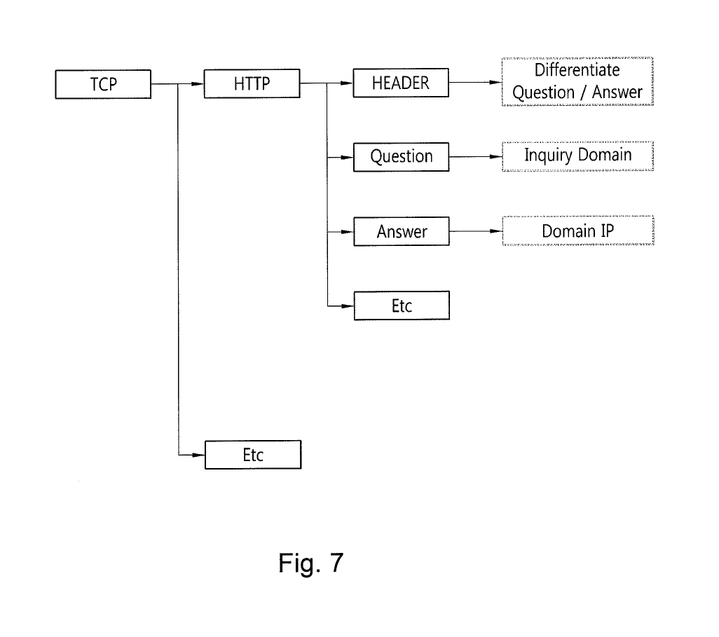

Table 1 illustrates network traffic pattern data for a system for modeling activity patterns of network traffic to detect botnets according to an embodiment of the invention. Also, FIG. 6 illustrates the modeling of a TCP access pattern in a system for modeling activity patterns of network traffic to detect botnets according to an embodiment of the invention, and FIG. 7 illustrates the modeling of a UDP access pattern in a system for modeling activity patterns of network traffic to detect botnets according to an embodiment of the invention.

TABLE 1
Categories

| | | |
|---|---|---|
| TCP | HTTP | Request |
| | | Response |

SMTP
Normal

| | | |
|---|---|---|
| UDP | DNS | Query |
| | | Answer |

Normal

Referring to Table 1, an embodiment of the invention may classify network traffic patterns mainly into transmission control protocols (hereinafter abbreviated as “TCP”), by which a transmitting side and a receiving side can communicate with each other, and user datagram protocols (hereinafter abbreviated as “UDP”), by which data is transferred in one direction when information is exchanged. Also, referring to Table 1 and FIG. 6, TCP may be classified into hypertext transport protocols (hereinafter abbreviated as “HTTP”), simple mail transfer protocols (hereinafter abbreviated as “SMTP”), and other transmission control protocols (normal). HTTP may be classified into “requests” for pages and “responses” from servers to user requests. Here, a SMTP may itself be used as pattern data, and for other TCP traffic, the TCP communication may itself be determined as pattern data. Also, referring to Table 1 and FIG. 7, UDP may be classified into DNS and other UDP (normal). For UDP traffic, the UDP communication itself may be determined as pattern data.

Table 2 illustrates a basis for access pattern modeling in a system for modeling activity patterns of network traffic to detect botnets.

TABLE 2

| Categories | | | Indicator | Sub-categories | | |
|---|---|---|---|---|---|---|
| TCP | HTTP | Request | T1 | Host ID | Page ID | Referrer ID |

| | | Response | T2 | Status Code ID |
|---|---|---|---|---|
| | SMTP | | T3 | |
| | Normal | | T4 | |
| UDP | DNS | Query | U1 | Domain ID |
| | | Answer | U2 | IP ID |

| | |
|---|---|
| Normal | U3 |

Referring to Table 2, an embodiment of the invention may further differentiate the protocols classified in Table 1 according to network traffic pattern. A fixed indicator, such as T1, T2, U1, etc., may be given for the main categories, and patterns may be expressed for the sub-categories correspondingly. The sub-categories for TCP's HTTP “Request”, which may be used to analyze the patterns of traffic for HTTP “Requests”, can include a host portion, which is the domain of the target of a request for a web server resource, a page portion, which includes information on a particular page desired by the host, and a referrer portion, which includes information on the preceding steps of a website currently accessed. Accordingly, there may be three data fields, to include Host ID, Page ID, and Referrer. For the TCP's HTTP “Responses”, the traffic patterning may be performed using the reply codes for the corresponding servers. The patterning for UDP's DNS queries may be performed using the domain names, while the patterning for the UDP's DNS answers may be performed using the IP addresses receives as replies.

Table 3 illustrates a pattern element data table for sub-categories in a system for modeling activity patterns of network traffic to detect botnets according to an embodiment of the invention.

TABLE 3

| ID | data |
|---|---|
| 1 | www.naver.com |
| 2 | www.daum.net |
| . | . |
| . | . |
| . | . |

Referring to Table 3, since it is likely that the host domain data for HTTP accesses and the domain data for DNS queries may overlap, the two types of data may share a single table. A host list is inserted as essential data in response to a HTTP request and may include domain names. A domain list is data included in a question regarding a DNS query and may include names of domains to which questions may be directed.

Table 4 is a page list in a system for modeling activity patterns of network traffic to detect botnets according to an embodiment of the invention.

TABLE 4

| ID | data |
|---|---|
| 1 | index.html |
| 2 | download.php |
| . | . |
| . | . |
| . | . |

Referring to Table 4, a page list may be expressed according to a HTTP request. The page list may include file names indicating detailed pages to request which server resources the corresponding domain (host) will use.

Table 5 illustrates a referrer list in a system for modeling activity patterns of network traffic to detect botnets according to an embodiment of the invention.

TABLE 5

| ID | data |
|---|---|
| 1 | http://search.naver.com/search.naver.. |
| 2 | http://www.google.co.kr/search?hl=ko&.. |
| . | . |
| . | . |
| . | . |

Referring to Table 5, a referrer list may include information regarding which links an object followed before arriving at the current page, with reference to a HTTP request. The referrer list may include uniform resource locator (hereinafter abbreviated as “URL”) information.

Table 6 illustrates a status code list in a system for modeling activity patterns of network traffic to detect botnets according to an embodiment of the invention.

TABLE 6

| ID | data |
|---|---|
| 1 | 1xx (Information Message) |
| 2 | 2xx (Success) |
| 3 | 3xx (Redirection) |
| 4 | 4xx (Client Error) |
| 5 | 5xx (Server Error) |

Referring to Table 6, status codes may include pattern data regarding a HTTP response and may be response codes indicating how the corresponding server processed a user's request for web server resources. As response codes, the status codes can also reveal the service status of the server. While various response codes can be implemented, this embodiment has been illustrated using an example in which codes for just the first digit, from among three digit numbers, are stored and used as pattern data.

Table 7 illustrates a query IP list in a in a system for modeling activity patterns of network traffic to detect botnets according to an embodiment of the invention.

TABLE 7

| ID | data |
|---|---|
| 1 | xxx.xxx.xxx.xxx |
| 2 | xxx.xxx.xxx.xxx |
| . | . |
| . | . |
| . | . |

Referring to Table 7, a query IP list may include data regarding responses to DNS queries, i.e. to “Answer” traffic patterns. The query IP list may include information on the IP of the domains to which the questions are directed.

Using the indicators and ID described above, an embodiment of the invention can model the activity patterns of the network traffic. For example, “T1.2.1” may represent an action of accessing Daum by directly inputting the address, while “T1.1.2.2” may represent an action of accessing Naver by searching on Google and clicking Further, “T2.3” may represent a redirection connection, and “T2.5” may represent a server access error.

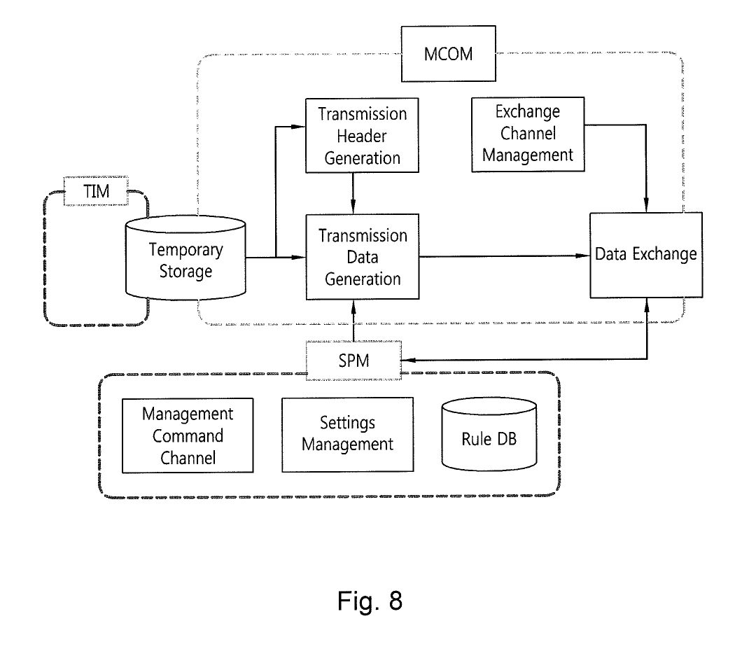

FIG. 8 illustrates the composition of a communication management module in a system for modeling activity patterns of network traffic to detect botnets according to an embodiment of the invention.

As illustrated in FIG. 8, the traffic information transmitter module may differentiate the traffic information parsed at the traffic information manager module into a transmission header and transmission data, and then package the data and transmit the data by way of a transmission channel to the botnet detection system.

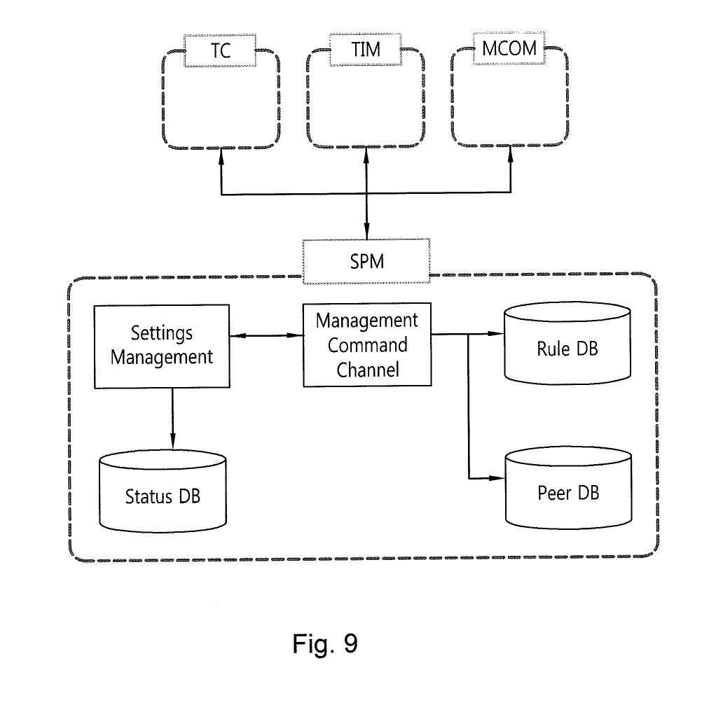

FIG. 9 illustrates the composition of a policy management module in a system for modeling activity patterns of network traffic to detect botnets according to an embodiment of the invention.

As illustrated in FIG. 9, the sensor policy manager module may oversee the overall settings management and control functions of the botnet traffic collector sensors and may interact with all of the other modules. Within the policy manager module, a settings management module may manage a status database, while a management command channel may update and manage a rule database and a peer database. The information of the rule database and the peer database may be applied after being received by a management communication module (MCOM). The traffic collector module (TIC), the traffic information manager module (TIM), and the management communication module (MCOM) may each access the status database and record a log concerning its operations.

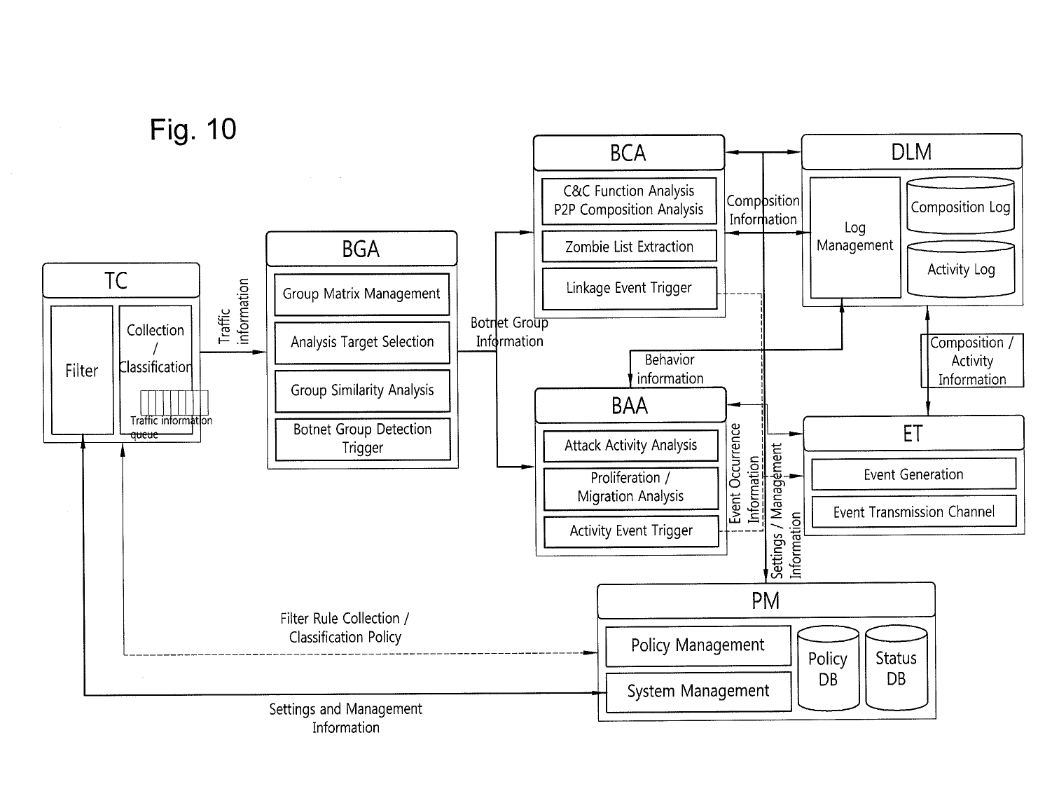

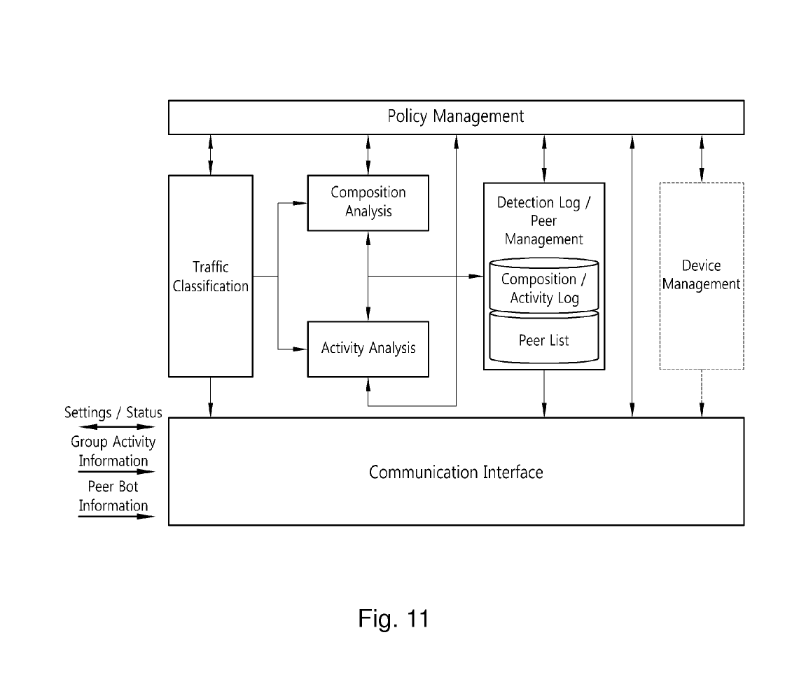

FIG. 10 illustrates the composition of a botnet detector system in a system for modeling activity patterns of network traffic to detect botnets according to an embodiment of the invention, and FIG. 11 illustrates the structure of a botnet detector system in a system for modeling activity patterns of network traffic to detect botnets according to an embodiment of the invention.

The botnet detection system may be provided within the network of an Internet service provider to detect botnets that are active within the network of the Internet service provider, based on the traffic information collected by the traffic collector sensors. More than one of such botnet detection systems can be included in the Internet service provider's network. Also, as illustrated in FIG. 10 and FIG. 11, the botnet detection system may include a botnet group analyzer module (BGA), a botnet composition analyzer module (BCA), a botnet activity analyzer module (BAA), a detection log management module (DLM), an event transmission module (ET), and a policy management module (PM).

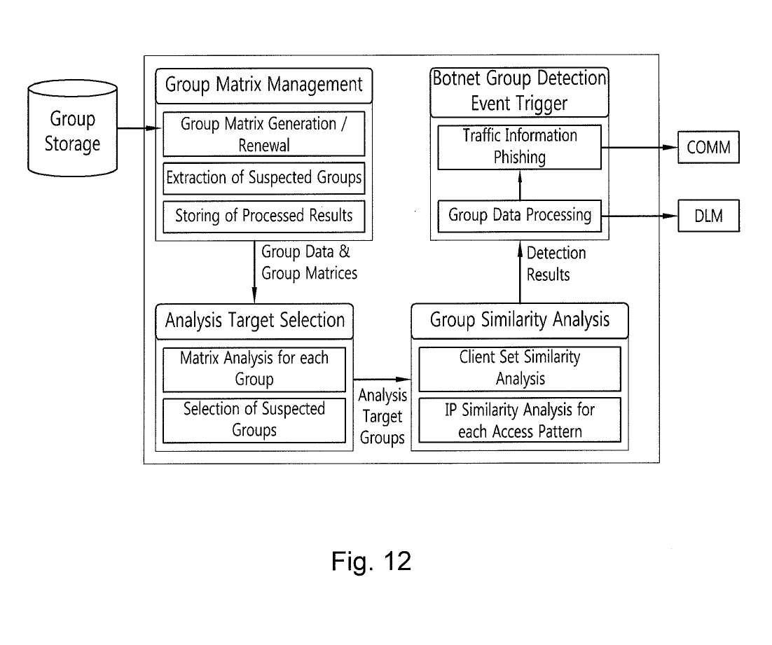

FIG. 12 illustrates the composition of a botnet group analyzer module in a system for modeling activity patterns of network traffic to detect botnets according to an embodiment of the invention.

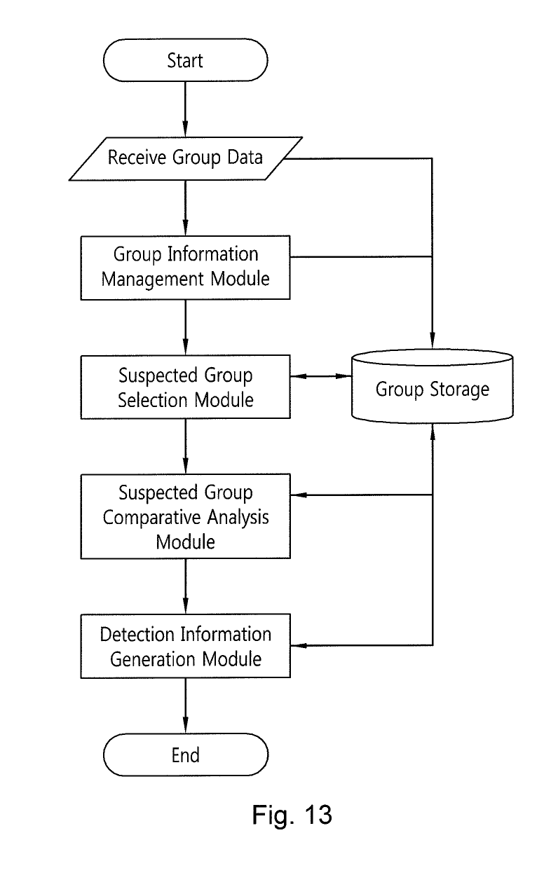

As illustrated in FIG. 12, the botnet group analyzer module (BGA) may determine botnet groups from the group data transmitted from the botnet traffic collector sensors. The group data transmitted from the botnet traffic collector sensors may generate/renew the matrices for the groups, with the renewal and deletion of the group matrices performed according to a group management algorithm. Here, if there are no updates for 50% or more of the clients of an entire group, then the deletion may be performed according to a stepwise management procedure. Also, the botnet group analyzer module may manage the matrices for the group data. This may entail updating the matrix of an existing group and generating a matrix for a new group. Regards the updating, if there are no actions by a group's clients for a certain amount of time, then the group matrix may be deleted, according to the group matrix management algorithm. Also, after the group matrices are updated, each of the group matrices may be evaluated, and if a particular access pattern exceeds a threshold number, then the corresponding group may be determined to be an analysis target group. Afterwards, the set of groups determined to be analysis target groups may be analyzed with regard to client similarity. If the similarity is above a certain value, for example, 80%, then the similarity may be analyzed for the detailed client list with reference to a particular, characteristic access pattern. Here, if the client similarity to the particular access pattern is above a certain value, for example, 80%, then the two corresponding groups may be determined to be of the same botnet. The analysis results of each module may be gathered and transmitted to a log manager, and a trigger message, which may be used later for policy-making, may be generated from the analysis results and transmitted to an event trigger. To perform the functions described above, the botnet group analyzer module may include a group information management module, a suspected group selection module, a suspected group comparative analysis module, and a detection information generation module. A more detailed description is provided as follows with reference to FIG. 13.

FIG. 13 is a flowchart illustrating the operation of a botnet group analyzer module in a system for modeling activity patterns of network traffic to detect botnets according to an embodiment of the invention.

Referring to FIG. 13, the group information management module may store the group data, which is received from the sensors, within the detection system, and generate a group matrix correspondingly. The group information management module may manage the number of group information items stored in the system, and in more detail, manage the updating of each of the group data and group matrices. Here, managing the group data and group matrices may be to apply the corresponding update, whereas managing the overall number of group information items may be to manage the number of group information items stored in the system at a geometric rate.

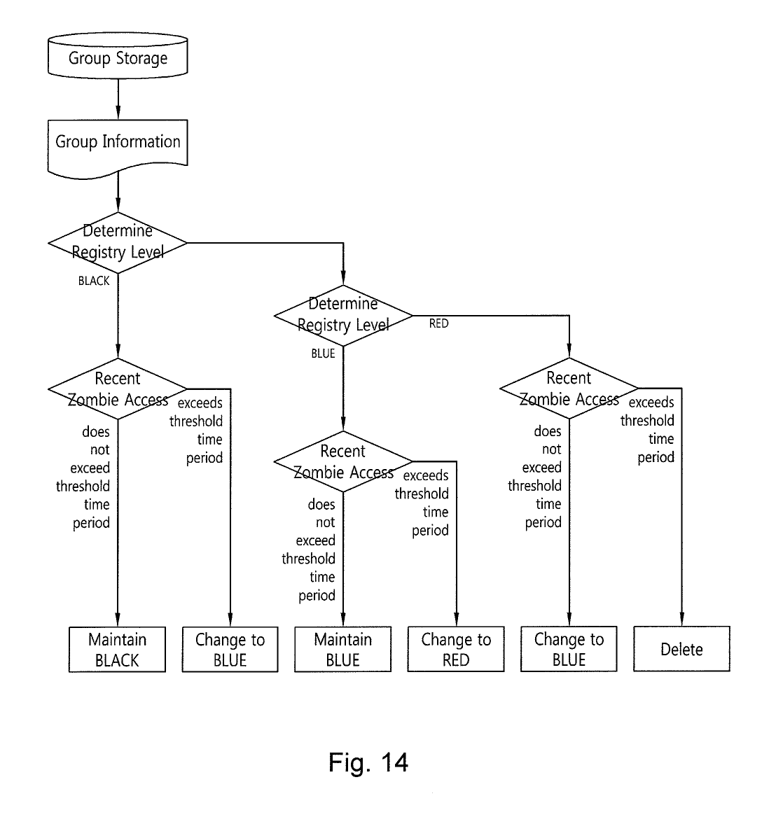

FIG. 14 is a flowchart illustrating the operation of a group information manager module in a system for modeling activity patterns of network traffic to detect botnets according to an embodiment of the invention.

Referring to FIG. 14, the group information can have several levels, and this embodiment is illustrated for an example that uses BLACK, RED, and BLUE levels. Here, BLACK can represent group information detected to be of a botnet, RED can represent non-active group information, and BLUE can represent regular group information. Managing the group information can entail comparing the difference between the most recent access time of a client and the current analyzing time with a threshold time period, where the level can be lowered if there is no access within the threshold time period. Preferably, for the non-active RED group, a deletion may be made if there is no client access for a duration exceeding the threshold time period. The group information management module may include a group data management module and a group matrix management module.

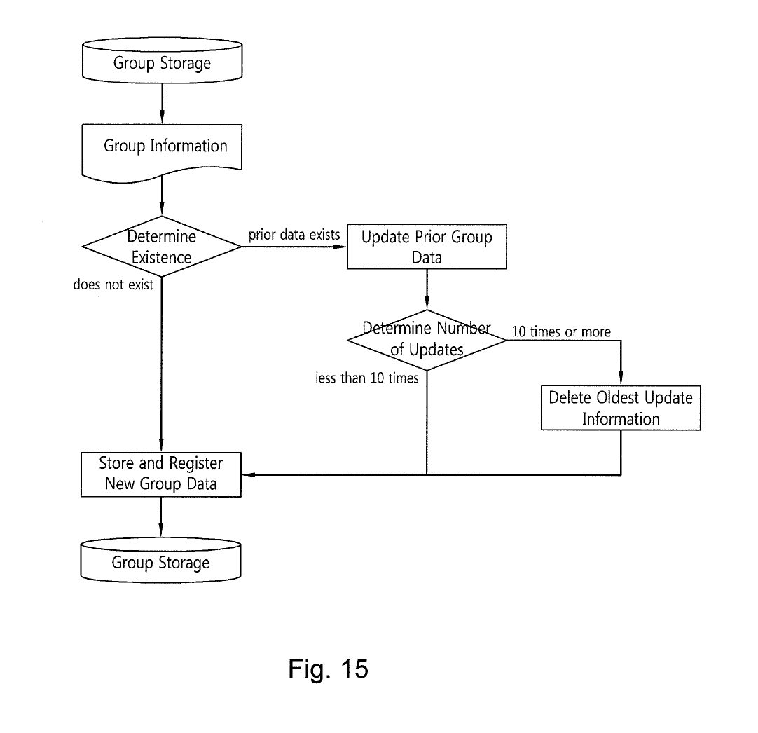

FIG. 15 is a flowchart illustrating the operation of a group data manager module in a system for modeling activity patterns of network traffic to detect botnets according to an embodiment of the invention.

Referring to FIG. 15, the group data management module may, within the botnet detection system, manage the group data received from the botnet traffic collector sensors. As the botnet detection system manages data received from many sensors, it is necessary to efficiently take care of a significant amount of group data. Thus, the data can be managed for just a particular time segment, which can be varied according to the amount of data collected. For example, a certain amount of group data can be managed over several time segments. Updates that are transmitted later can be maintained by having the newest updates applied and the oldest updates deleted.

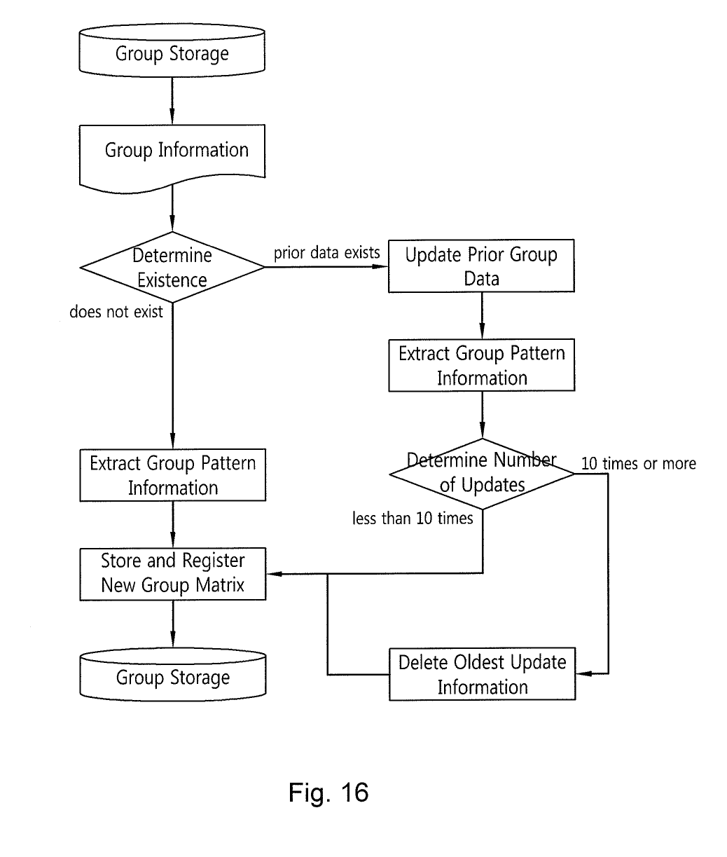

FIG. 16 is a flowchart illustrating the operation of a group matrix manager module in a system for modeling activity patterns of network traffic to detect botnets according to an embodiment of the invention.

Referring to FIG. 16, the group matrix management module may manage the matrices of groups, i.e. group matrices, in which the IP count following the access activity pattern occurring in the groups is analyzed and stored. Similar to the group data management module described above, the group matrix management module may also preferably manage the data only for a particular time segment.

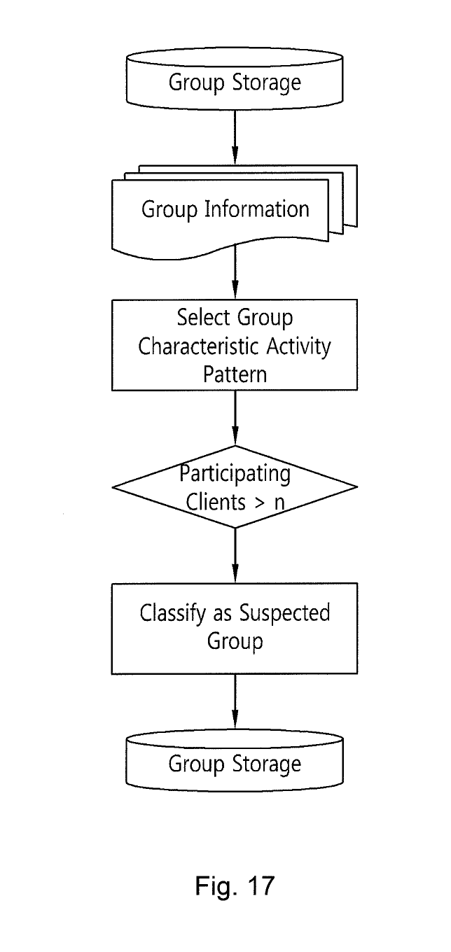

FIG. 17 is a flowchart illustrating the operation of a suspected group selector module in a system for modeling activity patterns of network traffic to detect botnets according to an embodiment of the invention.

Referring to FIG. 17, the suspected group selection module may select the groups suspected to be of a botnet from the managed group information, and may generate a list. That is, from among the group information carried by the botnet detection system, those groups may be selected that are suspected to belong to a botnet. In selecting the suspected groups, the suspected groups may be determined based on the scale of the clients for the activity in which the greatest number of clients participated, from among the activity matrix of the corresponding groups.

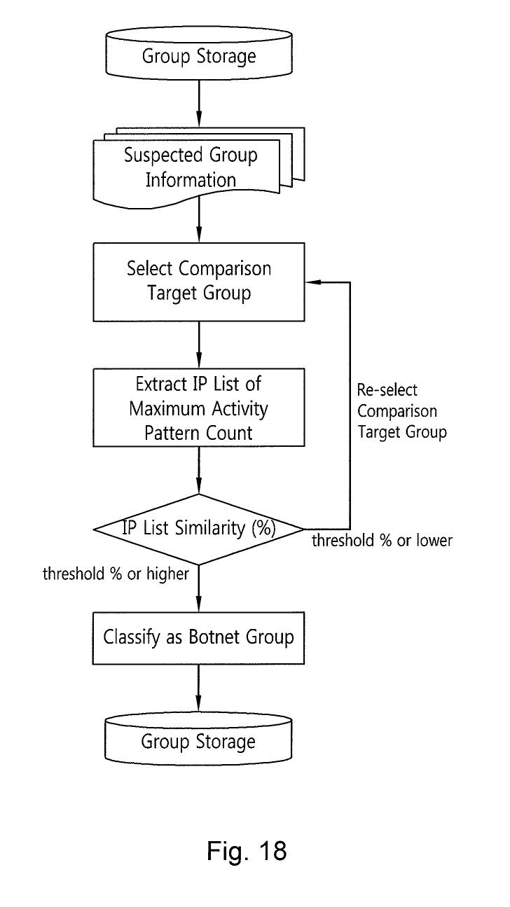

FIG. 18 is a flowchart illustrating the operation of a suspected group comparative analysis module in a system for modeling activity patterns of network traffic to detect botnets according to an embodiment of the invention.

Referring to FIG. 18, the suspected group comparative analysis module may determine botnet groups by comparing the mutual similarity of the groups classified as suspected groups. This may require selecting comparison target groups from the aggregate of suspected groups. Also, since a complete comparison is necessary for the comparison target groups, the order by which to compare the groups can be decided by arranging the groups by ID value, without using a particular order. For the two groups selected as comparison targets, the respective IP lists of clients that have shown the activity in which the greatest number of clients participated may be compared with each other. Here, since the client IP sets for the respective groups can have different sizes, it may be preferable to perform the analysis to a degree such that the smaller set becomes a subset of the larger set.

The detection information generation module may generate information regarding a botnet group determined by the suspected group comparative analysis module. Here, the information regarding the botnet group can include the IP of the clients, the activity of the botnet, etc.

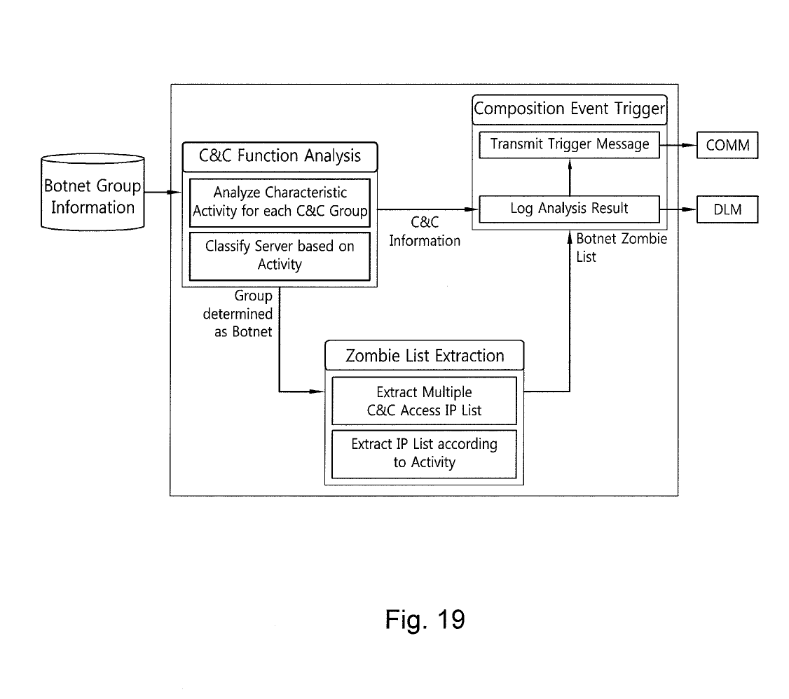

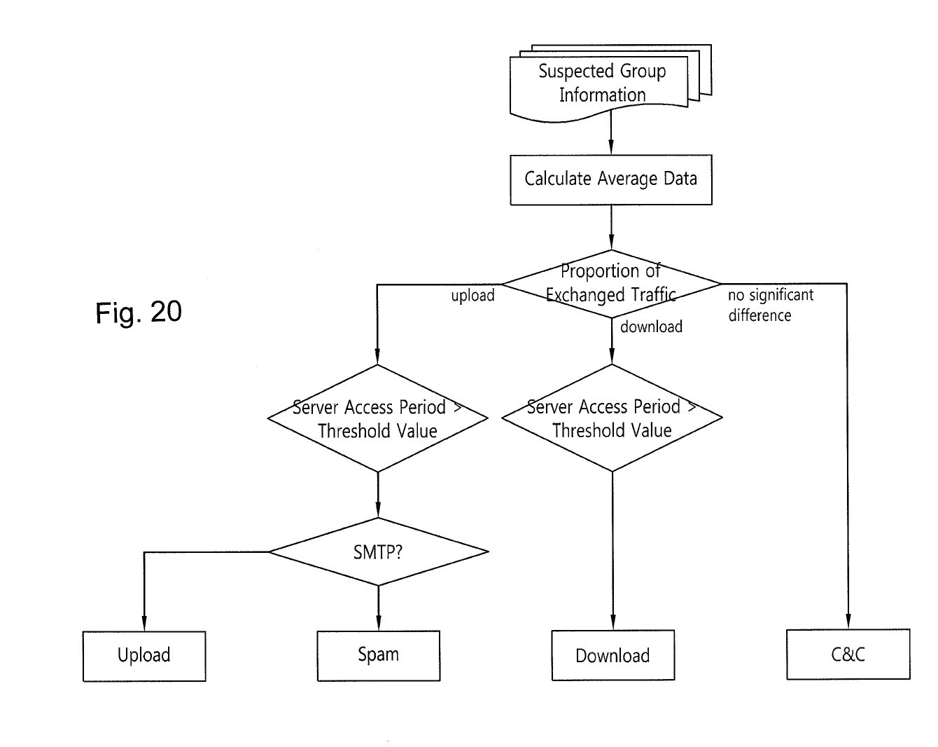

FIG. 19 illustrates the composition of a botnet composition analyzer module in a system for modeling activity patterns of network traffic to detect botnets according to an embodiment of the invention, and FIG. 20 is a flowchart illustrating the operation of a botnet composition analyzer module in a system for modeling activity patterns of network traffic to detect botnets according to an embodiment of the invention.

The botnet composition analyzer module (BCA), as illustrated in FIG. 19, is for analyzing the role of the C&C and extracting a zombie list, and may analyze the characteristic access pattern of each group of the aggregate of botnet groups detected as a botnet. It may also classify the role of each of the servers participating in the botnet, based on the group information regarding the access pattern. Here, with reference to FIG. 20, the classification can result in classifying into command control servers, download servers, upload servers, and spam servers. The IP list, i.e. zombie list, of each group may be extracted for the aggregate of groups detected as a botnet. The latest update time may be analyzed for each zombie list, and if the latest update time has a connectivity lower than or equal to a threshold value, then it may be determined to be a zombie. Here, the information may be arranged in such a way that makes it possible to analyze the latest server access time for each zombie, to thereby analyze how the composition of the botnet has evolved according to the role of each server. The analysis results from each module may be gathered and transmitted to the log manager. A trigger message, which may be used later for policy-making, may be generated from the analysis results and transmitted to the event trigger.

The botnet activity analyzer module (BAA) may analyze the attack activity of botnet groups and whether or not there was proliferation or migration of the botnet groups.

The detection log management module (DLM) may manage the logs of the composition information and activity information of the botnet groups and may include a composition information database and an activity information database for botnet groups.

The policy management module (PM) may establish the policies for the modules executed within the botnet monitoring/security management system. Also, the policy management module (PM) may establish a detection policy for the botnet detection system registered in the botnet monitoring/security management system. It may also establish a traffic information collector sensor policy by way of the registered botnet detection system.

The botnet monitoring/security management system may exchange various settings and status information with a monitoring system, and may receive group activity information and peer bot information, perform traffic classification, perform composition and activity analysis, and then store the results in a database. The composition and activity analysis information stored in the database may be transmitted back to the monitoring system.

As described above, an aspect of the invention can provide a system for modeling activity patterns of network traffic to detect botnets, where the system can classify the communication activities for each client to model network activity by differentiating the protocols of the collected network traffic based on destination and patterning the subgroups for the respective protocols. Also, an aspect of the invention can provide a system that can classify those servers that are estimated to be C&C servers into download and upload, spam servers and command control servers, within a botnet group detected by modeling network activity, i.e. analyzing network-based activity patterns. Furthermore, an aspect of the invention can provide a system that can detect botnet groups by way of a group information management function, for generating an activity pattern-based group matrix based on group data, and a mutual similarity analysis, performed on groups suspected to be botnets from the group information.

A description will now be provided of a method for modeling activity patterns of network traffic to detect botnets according to a first disclosed embodiment of the invention, with reference to the drawings. In the descriptions that follow, those descriptions that are redundant from the description of the system for modeling activity patterns of network traffic to detect botnets set forth above may be omitted or abridged.

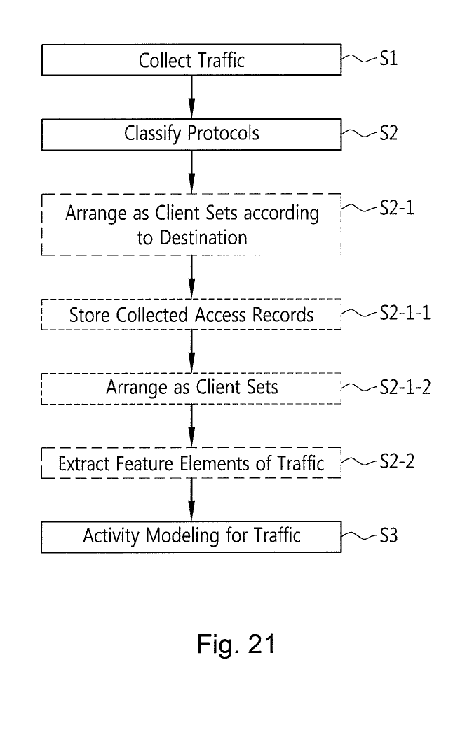

FIG. 21 is a flowchart illustrating a method for modeling activity patterns of network traffic to detect botnets according to a first disclosed embodiment of the invention.

As illustrated in FIG. 21, a method for modeling activity patterns of network traffic to detect botnets according to a first disclosed embodiment of the invention may include collecting traffic (S₁), classifying protocols (S₂), and modeling activities for the traffic (S₃).

In the operation of collecting traffic (S₁), the traffic data of a network may be collected according to a collection policy using a packet capturing tool. For this, traffic information collector sensors may be included in a multiple number of networks, collecting traffic information according to a traffic collection policy established by a botnet monitoring and security management system.

In the operation of classifying protocols (S₂), the traffic collected in the operation of collecting traffic may be classified according to protocol. The operation of classifying protocols may include arranging the collected traffic into client sets according to destination (S₂₋₁) and extracting feature elements of the traffic (S₂₋₂).

In the operation of arranging into client sets according to destination (S₂₋₁), the protocols collected in the operation of collecting traffic may be analyzed and arranged into client sets having the same destination. This operation of arranging into client sets according to destination (S₂₋₁) may include storing the collected access records (S₂₋₁₋₁) and arranging into client sets (S₂₋₁₋₂).

In the operation of storing the collected access records (S₂₋₁₋₁), the access records collected by the traffic information collector sensors may be stored, at the same time storing the access records collected over a certain time segment.

In the operation of arranging into client sets (S₂₋₁₋₂), the collected traffic information may be analyzed and differentiated according to protocol, and then arranged into client sets. As described above with reference to the system for modeling activity patterns of network traffic to detect botnets according to an embodiment of the invention, the protocols can be classified mainly into TCP and UDP, where the TCP may be classified into HTTP, SMTP, and other TCP. Also, the UDP may be classified into DNS and other UDP. In analyzing the protocols, the actual contents of the traffic may be analyzed and differentiated, and the group data may be arranged based on IP and port, i.e. the address of the destination.

In the operation of extracting feature characteristics of the traffic (S₂₋₂), the header and contents of the classified protocol packets may be analyzed to extract feature characteristics of the traffic.

In the operation of modeling the activities for the traffic (S₃), the headers of the TCP/IP layer and the IPv4 header from among the extracted feature characteristics of the traffic may be analyzed, to model the activities for the traffic. Afterwards, the modeled activity information for the traffic can be used in detecting botnets.

As described above, this embodiment of the invention can provide a method for modeling activity patterns of network traffic to detect botnets, where the method can classify the communication activities for each client to model network activity by differentiating the protocols of the collected network traffic based on destination and patterning the subgroups for the respective protocols. The embodiment can also provide a method that can classify those servers that are estimated to be C&C servers into download and upload, spam servers and command control servers, within a botnet group detected by modeling network activity, i.e. analyzing network-based activity patterns. Furthermore, the embodiment can provide a method that can detect botnet groups by way of a group information management function, for generating an activity pattern-based group matrix based on group data, and a mutual similarity analysis, performed on groups suspected to be botnets from the group information.

A description will now be provided of a method for modeling activity patterns of network traffic to detect botnets according to a second disclosed embodiment of the invention, with reference to the drawings. In the descriptions that follow, those descriptions that are redundant from the description of the method for modeling activity patterns of network traffic to detect botnets according to the first disclosed embodiment of the invention set forth above may be omitted or abridged.

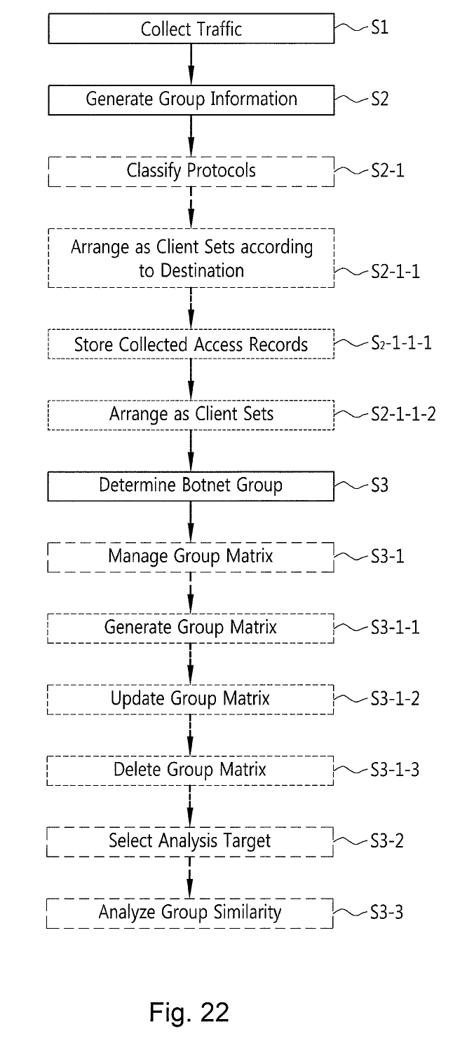

FIG. 22 is a flowchart illustrating a method for modeling activity patterns of network traffic to detect botnets according to a second embodiment of the invention.

As illustrated in FIG. 22, a method for modeling activity patterns of network traffic to detect botnets according to a second disclosed embodiment of the invention may include collecting traffic (S₁), generating group information (S₂), and determining botnet groups (S₃).

In the operation of collecting traffic (S₁), the traffic data of a network may be collected according to a collection policy using a packet capturing tool. For this, traffic information collector sensors may be included in a multiple number of networks, collecting traffic information according to a traffic collection policy established by a botnet monitoring and security management system.

In the operation of collecting traffic (S₂), the collected traffic may be grouped. For this, the operation of collecting traffic (S₂) may include classifying protocols (S₂₋₁).

In the operation of classifying protocols (S₂₋₁), the traffic collected in the operation of collecting traffic may be classified according to protocol. The operation of classifying protocols may include arranging the collected traffic into client sets according to destination (S₂₋₁₋₁).

In the operation of arranging into client sets according to destination (S₂₋₁₋₁), the protocols collected in the operation of collecting traffic may be analyzed and arranged into client sets having the same destination. This operation of arranging into client sets according to destination (S₂₋₁₋₁) may include storing the collected access records (S₂₋₁₋₁₋₁) and arranging into client sets (S₂₋₁₋₁₋₂).

In the operation of storing the collected access records (S₂₋₁₋₁₋₁), the access records collected by the traffic information collector sensors may be stored, at the same time storing the access records collected over a certain time segment.

In the operation of arranging into client sets (S₂₋₁₋₁₋₂), the collected traffic information may be analyzed and differentiated according to protocol, and then arranged into client sets. As described above with reference to the system for modeling activity patterns of network traffic to detect botnets according to an embodiment of the invention, the protocols can be classified mainly into TCP and UDP, where the TCP may be classified into HTTP, SMTP, and other TCP. Also, the UDP may be classified into DNS and other UDP. In analyzing the protocols, the actual contents of the traffic may be analyzed and differentiated, and the group data may be arranged based on IP and port, i.e. the address of the destination.

In the operation of determining botnet groups (S₃), the groups classified as suspected groups may be analyzed with respect to similarity, to determine botnet groups. This operation of determining botnet groups may include managing group matrices (S_{3- 1}), selecting analysis targets (S₃₋₂), and analyzing group similarity (S₃₋₃).

In the operation of managing group matrices (S₃₋₁), the matrices for the group data transmitted from the traffic information collector module, i.e. the group matrices, may be managed. Here, managing group matrices refers to generating, updating, and deleting group matrices, and thus the operation of managing group matrices may include operations for generating group matrices (S₃₋₁₋₁), updating group matrices (S₃₋₁₋₂), and deleting group matrices (S₃₋₁₋₃).

In the operation of generating group matrices (S₃₋₁₋₁), group matrices may be generated for new groups. That is, for a new group that did not exist before, there is no group matrix, and thus a new group matrix may be generated.

In the operation of updating group matrices (S₃₋₁₋₂), if a group did exist before, the matrix for the existing group may be updated. In the operation of deleting group matrices (S₃₋₁₋₃), if there are no actions by a group's clients for a certain amount of time, then the group matrix may be deleted, according to the group matrix management algorithm.

In the operation of selecting analysis targets (S₃₋₂), after the group matrices are updated, if a particular access pattern exceeds a threshold number for each of the group matrices, then the corresponding group may be selected as an analysis target group.

In the operation of analyzing similarity (S₃₋₃), the similarity of the clients may be analyzed for the aggregate of groups selected as analysis targets. If the similarity is above a certain level, for example, 80%, then the similarity may be analyzed for the detailed client list with reference to a particular, characteristic access pattern. Also, if the client similarity to the particular access pattern is above a certain level, for example, 80%, then the two corresponding groups may be determined to be of the same botnet.

As described above, this embodiment can provide a method that can detect botnet groups by way of a group information management function, for generating an activity pattern-based group matrix based on group data, and a mutual similarity analysis, performed on groups suspected to be botnets from the group information.

While the present invention has been described above with reference to particular drawings and embodiments, those skilled in the art will understand that numerous variations and modifications can be conceived without departing from the spirit of the present invention as disclosed by the scope of claims appended below.

What is claimed is:

1. A system for modeling activity patterns of network traffic to detect botnets, the system comprising:
a botnet traffic collector sensor configured to collect traffic within a network and classify the traffic according to destination; and
a botnet detector system configured to detect a botnet based on botnet traffic collected by the botnet traffic collector sensor.

2. The system of claim 1, wherein the botnet detector system arranges the traffic classified according to destination into groups for different time periods and then detects a botnet group having a particular access pattern exceeding a threshold number.

3. The system of claim 1, wherein the botnet traffic collector sensor comprises:
a traffic information collector module configured to collect traffic by capturing packets of a monitored network according to a collecting policy using a packet capturing tool;
a traffic information manager module configured to classify information received from the traffic information collector module, receive and parse traffic information, process group data, and store/manage the traffic information in a database;
a traffic information transmitter module configured to differentiate the traffic information parsed at the traffic information manager module into a transmission header and transmission data, package the data, and transmit the data by way of a transmission channel; and
a sensor policy manager module configured to transmit settings/status information of a classification tool, a traffic information manager tool, and data transmission cycle information to the traffic information collector module, the traffic information manager module, and the traffic information transmitter module.

4. The system of claim 3, wherein the traffic information manager module classifies patterns of the collected network traffic into transmission control protocols (TCP) and user datagram protocols (UDP).

5. The system of claim 4, wherein the traffic information manager module classifies the transmission control protocols (TCP) into hypertext transport protocols (HTTP), simple mail transfer protocols (SMTP), and other transmission control protocols besides the hypertext transport protocols and the simple mail transfer protocols,
and classifies the hypertext transport protocols into “requests” for pages and “responses” from servers to user requests.

6. The system of claim 5, wherein a simple mail transfer protocol communication is used as pattern data for the simple mail transfer protocols (SMTP),
and a user datagram protocol communication is determined as pattern data for the user data protocols (UDP).

7. The system of claim 5, wherein the “request” is classified into a host portion, which is a domain of a target of a request for a web server resource, a page portion, which includes information on a particular page desired by the host, and a referrer portion, which includes information on steps preceding a website currently accessed.

8. The system of claim 4, wherein the traffic information manager module classifies the user datagram protocols (UDP) into a domain name server (DNS) and other user datagram protocols besides the domain name server.

9. A method for modeling activity patterns of network traffic to detect botnets, the method comprising:
collecting traffic;
classifying protocols of the collected traffic; and
modeling activities for the classified traffic.

10. The method of claim 9, wherein the classifying of the collected traffic comprises:
arranging the collected traffic into client sets according to destination; and
extracting feature elements of the traffic arranged into client sets according to destination.

11. The method of claim 10, wherein the arranging of the collected traffic into client sets according to destination comprises:
storing access records of the collected traffic; and
arranging the collected traffic into client sets according to destination.

12. A method for modeling activity patterns of network traffic to detect botnets, the method comprising:
collecting traffic;
generating group information for the collected traffic; and
determining a botnet group based on the group information,
wherein the group information includes group data and a group matrix, the group data including information on a plurality of sources for a single destination, the group matrix including stored data obtained after analyzing an IP count according to an access activity pattern occurring in the group data.

13. The method of claim 12, wherein the generating of the group information for the collected traffic comprises:
classifying the collected traffic according to protocol.

14. The method of claim 13, wherein the classifying of the collected traffic according to protocol comprises:
arranging the collected traffic into client sets according to destination.

15. The method of claim 12, wherein the determining of the botnet group based on the group information comprises:
managing group matrices; and
if a particular access pattern exceeds a threshold number for each of the group matrices, selecting the corresponding group as an analysis target group.

16. The method of claim 15, wherein the managing of the group matrices comprises:
generating a group matrix if the group matrix does not exist;
updating a group matrix if the group matrix does exist; and
deleting a group matrix if the group matrix has not been updated for a particular duration or by a particular proportion.

17. The method of claim 12, further comprising:
analyzing client similarity with respect to a particular access pattern for the group matrices selected as analysis targets.

18. The method of claim 17, wherein the analyzing of client similarity comprises:
among the group matrices selected as analysis targets, if the client similarity with respect to a particular access pattern for the group matrices is greater than a particular value for the group matrices of which the similarity is compared, then determining that the group matrices of which the similarity is compared belong to a same botnet group.
